(19) United States
(12) Patent Application Publication
(10) Pub. No.: US 2026/0353367 A1
(43) Pub. Date: Nov. 5, 2026

(54) Systems and Methods for Backhaul Link Beam Indication in Repeaters

(71) Applicant: Telefonaktiebolaget LM Ericsson (PUBL), Stockholm (SE)

(72) Inventors: Magnus Åström, LUND (SE); Boris Dortschy, VENDELSÖ (SE); Andreas NILSSON, Göteborg (SE); Behrooz Makki, PIXBO (SE); Lei Bao, GÖTEBORG (SE)

(21) Appl. No.: 19/123,587

(22) PCT Filed: Oct. 24, 2023
(86) PCT No.: PCT/IB2023/060733

§ 371 Date: Apr. 23, 2025

Related U.S. Application Data
(60) Provisional application No. 63/380,847, filed on Oct. 25, 2022.

(51) Int. Cl. H04W 72/0446; H04B 7/155; H04W 72/23; H04W 88/04

(52) U.S. Cl. CPC H04W 72/0446; H04B 7/15557; H04W 72/23; H04W 88/04

(57) ABSTRACT

A method (900) by a network node (110) for operation of a control link (70) and/or backhaul link (75) includes sending (902), to a repeater node (55), a set of candidate Transmission Configuration Indicator, TCI, states. The network node indicates (904), to the repeater node, a multiplexing operational mode of the control link and the backhaul link of the repeater node for a time resource. The network node indicates (906), to the repeater node, an indication of a TCI state for at least one of the control link and the backhaul link of the repeater node for the time resource based on the multiplexing operational mode.

### TECHNICAL FIELD

The present disclosure relates, in general, to wireless communications and, more particularly, systems and methods for backhaul link beam indication in repeaters.

### BACKGROUND

To increase the data rate and support the increasing number of user equipments (UEs), different methods are considered, among which network densification and millimeter wave (mmW) communications are the dominant ones. Network densification refers to the deployment of multiple access points of different types in, for example, metropolitan areas. Particularly, it is expected that in the future small nodes, such as relay nodes, Integrated Access and Backhauls (IABs), repeaters, etc., will be densely deployed to support existing macro base stations (BS) serving UEs.

During the 3^{rd} Generation Partnership Project (3GPP) Release 16 and Release 17, IAB has been well studied as the main relaying technique in 5^{th} Generation (5G), and the discussions will continue in Release 18 on Mobile IAB. Here, using a decode-and-forward relaying technique, the IAB can well extend the coverage and/or increase the throughput. However, IAB may be a relatively complex and expensive node and thereby, depending on the deployment, we may require alternative nodes with low complexity/cost for coverage blind spot removal, for example. Here, a candidate type of network node are radio frequency (RF) repeaters, which simply amplify-and-forward any signal that is received. RF repeaters have been considered in 2^{nd} Generation (2G), 3^{rd} Generation (3G) and 4^{th} Generation (4G) to supplement the coverage provided by regular full-stack base stations. However, RF repeaters lack in accurate beamforming which may limit their efficiency in, for instance, Frequency Range 2 (FR2).

With this background, a study-item has been considered in 3GPP Release 18 on network-controlled repeaters (NCR), which finalized in August 2022 and is followed by a work-item. In one alternative, an NCR can be a normal repeater with beamforming capabilities. In this way, the NCR should be considered as a network-controlled “beam bender” when compared to a gNodeB (gNB). As such, it is logically part of the gNB for all management purposes. For example, it is likely that the NCR is deployed and under the control of the operator. NCR is based on an amplify-and-forward relaying scheme, and it is likely to be limited to single-hop communication in stationary deployments with the focus on FR2. In other words, NCR is an enhancement over conventional RF repeaters with the capability to receive and process side control information from the network. Side control information could allow an NCR to perform an amplify-and-forward operation in a more efficient manner. Potential benefits could include, for instance, mitigation of unnecessary noise amplification, transmissions and receptions with better spatial directivity, simplified network integration, etc.

The objectives of a New Radio (NR) NCR work item follow in principle the recommendations defined in 3GPP TR 38.867. See, 3GPP TR 38.867, “Study on NR network-controlled repeaters”, V1.0.0, September 2022. With these recommendations, NR NCR supports the following features:
Specify the signalling and behaviour of the following side control information for controlling the NCR-Fwd [RAN1, RAN2]
   Beamforming
   UL-DL TDD operation
   ON-OFF information

See, RP-222673, New WID on NR network-controlled repeaters, 3GPP TSG RAN Meeting #97-e, September 2022.

In a typical NCR deployment, the NCR consists of two principal building blocks, namely, the NCR mobile termination (NCR-MT) and the NCR forwarding (NCR-Fwd) with following functions:
The NCR-MT is defined as a function entity to communicate with a gNB via control link to enable the information exchanges. The control link is based on NR Uu interface.
The NCR-Fwd is defined as a function entity to perform the amplify-and-forwarding of UL/DL RF signal between gNB and UE via backhaul link and access link. The behavior of the NCR-Fwd will be controlled according to the received side control information from gNB

See, “Chairman's Notes”, 3GPP TSG RAN WG1 Meeting #109-e, May 2022.

The NCR is equipped with an antenna configuration, where a signal is first received in downlink (DL) (or uplink (UL)), and, for example, after power amplification, transmitted further in DL (or UL). Since the NCR-Fwd module only amplifies and (analogously) beamforms the signal, no advanced receiver or transmitter chains are required, which reduce the cost and energy consumption of the NCR as compared to, for example, a normal Transmission and Reception Point (TRP). In its simplest (and, practical) architecture, different antenna modules are used for the BS-and UE-sides (i.e., the antennas targeting the gNB and UEs, respectively). By contrast, a more complex architecture, including self-interference cancellation, would allow for using the same antenna modules for both sides.

The NCR-MT module is used to exchange control and status signaling with a gNB via the control link. This signaling is used to control the NCR. For this, the NCR-MT module supports at least a sub-set of UE functions. In the BS-side, the NCR-MT module might be equipped with antenna separated from the antenna used by the NCR-Fwd module. However, in most configurations, at the BS-side, the NCR-MT and NCR-Fwd modules will share antenna configurations. Particularly, motivated by cost-efficient implementation and a unified beamforming framework for the NCR-MT and NCR-Fwd functionalities, it is beneficial to have an architecture with shared NCR-MT and NCR-Fwd antennas on the BS-side.

In general, the NCR-MT and the NCR-Fwd modules may be operating at the same, different, or overlapping frequencies. For example, the NCR-Fwd may operate at a high frequency band such as, for example, FR2, and the NCR-MT may be operating at a low frequency band such as, for example, Frequency Range 1 (FR1). However, controlling the backhaul link will be much simplified if the NCR-MT and NCR-Fwd operate in the same carrier.

The NCR-Fwd's amplify-and-forward operation is controlled through the NCR-MT. The NCR-MT may be directly responsible for the beamforming control on the access antenna side (i.e., to/from served UEs). In an alternative, the beamforming on the access antenna side is operated by the NCR-Fwd under control of the NCR-MT. On the BS antenna side (i.e., to/from the controlling gNB), the NCR-MT may be directly responsible for the beamforming control. Here, it is important to note that the beam control of the NCR UE-side should be conducted smoothly to minimize the impact on cell-common and UE-specific signals/channels that are forwarded toward the UEs. Also, a beam arrangement including both wider and narrower beams is required to accommodate both broadcast and unicast signals.

Regarding the beam indication for backhaul link, following agreement(s) has been achieved in RAN1 #109:

### Agreement

As baseline, the same TCI states as [control link] are assumed for beam at NCR-Fwd for backhaul link if the NCR-MT's carrier(s) is within the set of carriers forwarded by the NCR-Fwd.
[For Future Study (FFS)]: additional indication from gNB to determine the beam at NCR-Fwd for backhaul link or implicit determination of the beam at NCR-Fwd for backhaul link

Note: the same assumption of the beam correspondence is applied for DL/UL of the backhaul link at NCR-Fwd as the DL/UL of the [control link] at NCR-MT.

### Agreement

Both fixed beam and adaptive beam can be considered at NCR for both [control link] and backhaul-link.

FFS: the mechanism for indication and determination of beam.

Note: Fixed beam refers to the case that beam at NCR for both [control link] and backhaul-link cannot be changed.

### Agreement

Recommend to capture the following examples of the transmission/reception of [control link] and backhaul link by NCR in 3GPP TR 38.867.
The DL of [control link] and DL of backhaul link can be performed simultaneously or in [Time Division Multiplexing (TDM)]] way.
The UL of [control link] and UL of backhaul link can be performed in TDM way

Note-1: Multiplexing is under the control of gNB with consideration for NCR capability

Note-2: Simultaneous transmission of the UL of [control link] and UL of backhaul link is subject to NCR's capability

See, “Chairman's Notes”, 3GPP TSG RAN WG1 Meeting #109-e, May 2022. In addition, following agreement has been achieved in RAN1 #110:

### Agreement

In case that adaptive beams are adopted for [control link] and backhaul link, the following mechanisms can be considered for the indication and determination of beams of backhaul link:
Option 1: The beam of backhaul link is indicated by a new signaling.
   The new signaling is dynamic signaling and/or semi-static signaling (e.g., [Radio Resource Control (RRC)] signaling/Medium Access Control-Control Element (MAC CE)] indicating a beam(s) from the set of beams of the [control link]
   This does not imply that the beam of backhaul link is always indicated by the new signaling
Option 2: The beam of backhaul link is determined by a pre-defined rule.
   In slots/symbols with simultaneous DL receptions/UL transmissions in both [control link]and backhaul link, the beam of backhaul link is the same as the beam of [control link]. Otherwise, the beam of backhaul link follows one of the beams of the [control link].

See, “Chairman's Notes”, 3GPP TSG RAN WG1 Meeting #110-e, August 2022.

Other predefined rules are not precluded

### Beam Management Procedure

In high frequency range (e.g., FR2), multiple RF beams may be used to transmit and receive signals at a gNB and a UE. For each DL beam from a gNB, there is typically an associated best UE Receive (Rx) beam for receiving signals from the DL beam. The DL beam and the associated UE Rx beam forms a beam pair. The beam pair can be identified through a so-called beam management process in NR.

A DL beam is typically identified by an associated DL reference signal (RS) transmitted in the beam, either periodically, semi-persistently, or aperiodically. For this purpose, the DL RS can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of different DL-RSs in the reported best DL beam to let the UE evaluate candidate UE RX beams.

Although not explicitly stated in the NR specification, beam management has been divided into three procedures, which are schematically illustrated FIG. 1. The three procedures are as follows:
P-1: Purpose is to find a coarse direction for the UE using wide gNB Transmit (TX) beam covering the whole angular sector
P-2: Purpose is to refine the gNB TX beam by doing a new beam search around the coarse direction found in P-1.
P-3: Used for UE that has analog beamforming to let them find a suitable UE RX beam.

P-1 is expected to utilize beams with rather large beamwidths, and the beam reference signals are transmitted periodically and are shared between all UEs of the cell. Typically, the reference signals to use for P-1 are periodic CSI-RS or SSB. The UE then reports the N best beams to the gNB and their corresponding Reference Signal Received Power (RSRP) values.

P-2 is expected to use aperiodic/or semi-persistent CSI-RS transmitted in narrow beams around the coarse direction found in P-1.

P-3 is expected to use aperiodic/or semi-persistent CSI-RSs repeatedly transmitted in one narrow gNB beam. One alternative way is to let the UE determine a suitable UE RX beam based on the periodic SSB transmission. Since each SSB consists of four OFDM symbols, a maximum of four UE RX beams can be evaluated during each SSB burst transmission. One benefit with using SSB instead of CSI-RS is that no extra overhead of CSI-RS transmission is needed.

### Beam Indication

In NR, the spatial Quasi Co-Located (QCL) relation for a DL or UL signal/channel can be indicated to the UE by using a “beam indication.” The “beam indication” is used to help the UE find a suitable RX beam for DL reception, and/or a suitable TX beam for UL transmission. In NR, the beam indication for DL is conveyed to the UE by indicating a transmission configuration indicator (TCI) state to the UE, while in UL the beam indication can be conveyed by indicating a DL-RS or UL-RS as spatial relation (in NR Release 15/16) or a TCI state (in NR Release 17).

In NR, several signals can be transmitted from different antenna ports of a same base station. These signals can be received with the similar large-scale properties such as Doppler shift/spread, average delay spread, or average delay on different antenna ports. These receive antenna ports are then said to be QCL.

If the UE knows that two of its antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the Physical Downlink Shared Channel (PDSCH) Demodulation Reference Signal (DMRS). When the UE receives the PDSCH DMRS, the UE can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL Type D was introduced in NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal the UE has received earlier, then the UE can safely use the same RX beam to also receive this signal.

There currently exist certain challenge(s), however. For example, in the RANI #109bis meeting, it was agreed that the default manner is that the backhaul link and the control link share the fixed beam in a time domain multiplexing (TDMed) manner when communicating to the controlling gNB. Further, the repeater node can report additional beam capabilities such as, for example:
simultaneous transmission and reception of the backhaul and control links; and/or
adaptive beamforming of the control and/or backhaul links.

The beam indication of the control link can follow the legacy beam indication framework based on TCI states. In order to ensure a reliable backhaul link, however, there is a need of methods to develop efficient signaling.

### SUMMARY

Certain aspects of the disclosure and their embodiments may provide solutions to these or other challenges. For example, according to certain embodiments, methods and systems are provided for determining beam indication for the backhaul link of the repeater node in the presence or absence of the control link.

According to certain embodiments, a method by a network node for operation of control and/or backhaul links includes sending, to a repeater node, a set of candidate TCI states, The network node indicates, to the repeater node, a multiplexing operational mode of a control link and a backhaul link of the repeater node for a time resource. The network node also indicates, to the repeater node, an indication of a TCI state for at least one of the control link and the backhaul link of the repeater node for the time resource based on the multiplexing operational mode.

According to certain embodiments, a network node for operation of control and/or backhaul links is adapted to send, to a repeater node, a set of candidate TCI states, The network node is adapted to indicate, to the repeater node, a multiplexing operational mode of a control link and a backhaul link of the repeater node for a time resource. The network node is also adapted to indicate, to the repeater node, an indication of a TCI state for at least one of the control link and the backhaul link of the repeater node for the time resource based on the multiplexing operational mode.

According to certain embodiments, a method by a repeater node for operation of control and/or backhaul links includes receiving, from a network node, a set of candidate TCI states. The repeater node obtains information indicating a multiplexing operational mode of a control link and a backhaul link of the repeater node for a time resource. The repeater node also obtains an indication of a TCI state for at least one of the control link and the backhaul link of the repeater node for the time resource based on the multiplexing operational mode. The repeater node activates or deactivates the TCI state for the at least one of the control link and the backhaul link for the time resource based on the multiplexing operational mode.

According to certain embodiments, a repeater node for operation of control and/or backhaul links is adapted to receive, from a network node, a set of candidate TCI states. The repeater node is adapted to obtain information indicating a multiplexing operational mode of a control link and a backhaul link of the repeater node for a time resource. The repeater node is also adapted to obtain an indication of a TCI state for at least one of the control link and the backhaul link of the repeater node for the time resource based on the multiplexing operational mode. The repeater node is adapted to activate or deactivate the TCI state for the at least one of the control link and the backhaul link for the time resource based on the multiplexing operational mode.

Certain embodiments may provide one or more of the following technical advantage(s). For example, certain embodiments may provide a technical advantage of enabling the controlling gNB to control the backhaul link beam of a repeater node in different operation modes with respect to the control link. As such, certain embodiments may provide a technical advantage of enabling scheduling of a beam that might otherwise not be possible to schedule due to too high self interference between the backhaul and access link.

As another example, certain embodiments may provide a technical advantage of improving the energy efficiency of the repeater-assisted networks and, thus, addresses one of the main objectives of the 3 GPP Release 18 WID on NCRs.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of beam management procedure;

FIG. 2 illustrates an example of an NCR deployment, according to certain embodiments;

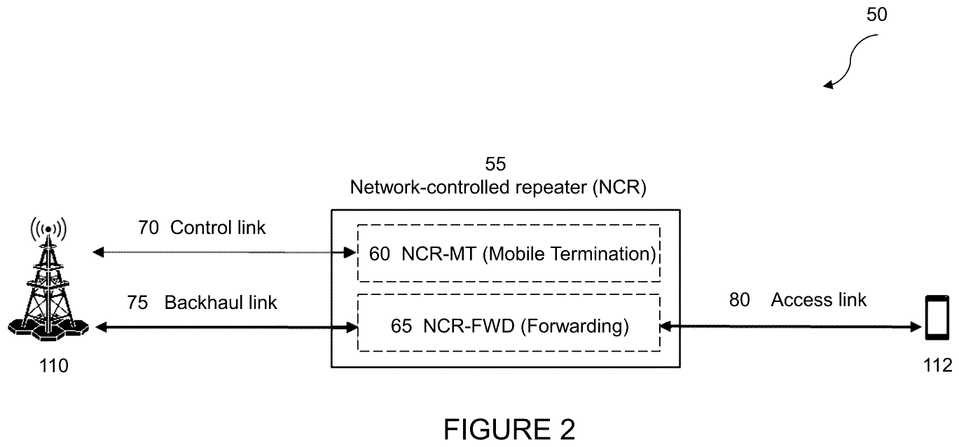

FIG. 3 illustrates a method for simultaneous operation of the control and backhaul links, according to certain embodiments;

FIG. 4 illustrates another example method for simultaneous operation of control and backhaul links, according to certain embodiments;

FIG. 5 illustrates an example communication system, according to certain embodiments;

FIG. 6 illustrates an example UE, according to certain embodiments;

FIG. 7 illustrates an example network node, according to certain embodiments;

FIG. 8 illustrates a block diagram of a host, according to certain embodiments;

FIG. 9 illustrates a virtualization environment in which functions implemented by some embodiments may be virtualized, according to certain embodiments;

FIG. 10 illustrates a host communicating via a network node with a UE over a partially wireless connection, according to certain embodiments;

FIG. 11 illustrates a method by a network node for operation of control and/or backhaul links, according to certain embodiments; and

FIG. 12 illustrates a method by a repeater node for operation of control and/or backhaul links, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, ‘radio network node’ or simply ‘network node (NW node)’, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

As used herein, simultaneous transmission and simultaneous reception of backhaul and control links refers to the scenario where the backhaul and control links share the same beam.

As used herein, TDM refers to an operation when a time resource is used either for backhaul or control link transmission.

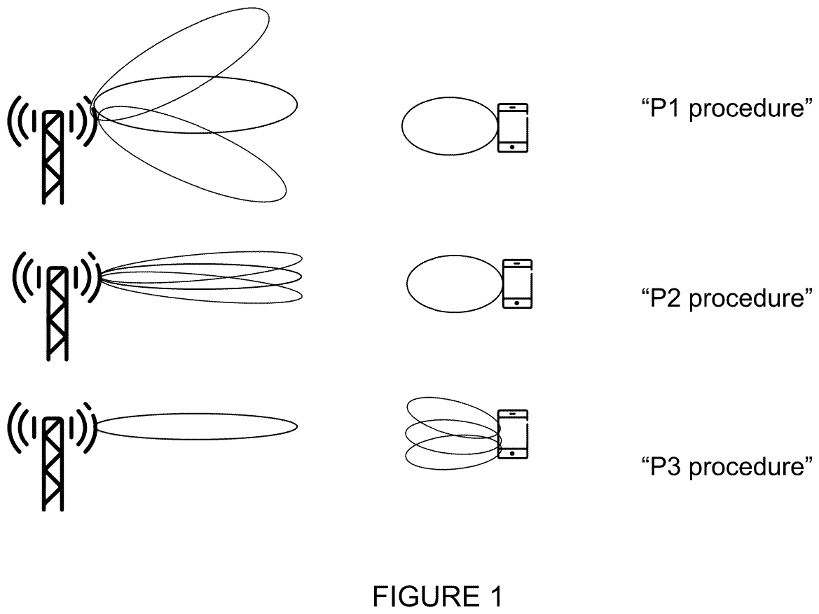

FIG. 1 illustrates an example NCR deployment 50 including a Network-controlled repeater (NCR) 55 for communicating between a network node (e.g., gNB) 110 and UE 112, according to certain embodiments. Herein the terms NCR and repeater node are used interchangeably.

As described above, the NCR 55 consists of a NCR mobile termination (NCR-MT) 60 and the NCR forwarding (NCR-Fwd) 65. As illustrated, the NCR-MT 60 communicates with the network node 110 via control link (C-link) 70 to enable the information exchanges. The C-link 70 is based on NR Uu interface.

The NCR-Fwd 65 performs the amplify-and-forwarding of UL/DL RF signal between network node 110 and UE 112 via backhaul link 75 and access link 80. The behavior of the NCR-Fwd 65 is controlled according to the received side control information from the network node 110.

According to certain embodiments, methods and systems are provided for determining beam indication for the backhaul link 75 of the repeater node 55 in the presence or absence of the control link 70. For example, according to certain embodiments, a method by a network node 110 for operation of the control link 70 and/or backhaul link 75 includes sending, to the repeater node 55, a set of candidate TCI states. The method includes the network node 110 indicating, to the repeater node 55, a multiplexing operational mode of the control link 70 and backhaul link 75 of the repeater node 55 for a time resource. The method also includes the network node 110 indicating, to the repeater node 55, an indication of a TCI state for at least one of the control link 70 and the backhaul link 75 of the repeater node 55 for the time resource based on the multiplexing operational mode.

As another example, according to particular embodiments, a method performed by a network node 110 such as a gNB, for example, includes: 1) determining a set of candidate TCI states for the backhaul link 75 (simultaneously with the control link 70 or separately), 2) determining the multiplexing operational mode for the backhaul link 75, and 3) determining and activating the appropriate TCI state for the backhaul link 75 of the repeater node 55.

As another example, according to certain embodiments, a method by/in a wireless network node 110, for configuring the behaviour of a spatial filter of a repeater node backhaul link 75, includes:
a) sending a message containing a set of candidate TCI states to the repeater node 55;
b) indicating a multiplexing operational mode for the backhaul link 75 of the repeater node 55 for a time resource; and
c) indicating a TCI state for the control link 70 and/or backhaul link 75 of the repeater node 55 for the said time resource based on the determined multiplexing operational mode.

In a further particular embodiment, prior to the steps described above being performed, the network node 110 receives from the repeater node 55 a backhaul link beam capability report, including a selection of at least one of:
a) support of simultaneous transmission and/or reception of the control link 70 and the backhaul link 75;
b) support of simultaneous DL and/or UL of the control link 70 and the backhaul link 75;
c) support of adaptive beamforming of the control link 70 and/or the backhaul link 75;
d) . . .

In a further particular embodiment, the method includes determining, by the network node 110, the set of candidate TCI states for the control and/or backhaul link beams, based on one or more of:
a) received signal quality (e.g., received power level, SNR)
b) self-interference level with respect to access link beams
c) averaged performance with respect to signal level and interference level
d) interference level at the wireless network node 110
e) interference level at the repeater node 55
f) network traffic condition
g) . . .

In a further particular embodiment, the set of candidate TCI states contains TCI states for simultaneous operation of backhaul link 75 and control-link 70 and TCI states for the operation of the backhaul link 75 only.

In a further particular embodiment, the multiplexing operational mode of the backhaul link 75 can be one of:
a) simultaneous operation with the control link 70, e.g., DL and/or UL
b) time domain multiplexing with the control link 70, e.g., DL and/or UL
c) frequency domain multiplexing with the control link 70, e.g., DL and/or UL
d) . . .

In a further particular embodiment, the multiplexing operational mode can be indicated implicitly or explicitly.

In a particular embodiment, the determination of the multiplexing operational mode of the backhaul link 75 is based on one or more of:
a) a reported repeater node backhaul beam capability;
b) a network traffic condition;
c) a TDD UL/DL pattern;
d) a self-interference level;
e) a network interference level;
f) an energy saving mode of the repeater-MT (e.g., the DRX configuration etc.);
g) a need of side control information for the repeater node 55;
h) a need of Acknowledgement (ACK)/Non-Acknowledgment (NACK) for the repeater node 55 or UE 112;
i) . . .

In a particular embodiment, the indication of the TCI state for simultaneous operation of the backhaul link 75 and control link 70 can be based on one or more of:
a) a preferred control link beam in terms of, for example, received power level, interference condition (SINR), etc.;
b) a preferred backhaul link beam in terms of, for example, received power level, interference condition (SINR), etc.;
c) averaged performance for both control and backhaul links in term of signal level and interference/noise level;
d) a recently indicated beam for the repeater control link 70;
e) a recently indicated beam for the backhaul link 75;
f) . . .

In a particular embodiment, the time resource of the TCI state for simultaneous operation of the backhaul link 75 and control link 70 can be associated to a signal or a channel configured to the repeater-MT, such as PDSCH, Physical Downlink Control Channel (PDCCH), Physical Uplink Shared Channel (PUSCH), Physical Uplink Control Channel (PUCCH), etc.

In a particular embodiment, the indication of the TCI state for the backhaul link 75 in the absence of the control link 70 can be based on one or more of, for example:
a) a default backhaul beam;
b) a predefined rule or specification;
c) following the recently indicated beam for the repeater control link;
d) interference level with respect to a determined access beam;
e) a new backhaul beam indication (e.g., an explicit backhaul beam indication) based on measurement from repeater-MT;
f) . . .

In a particular embodiment, the time resource of the TCI state for the backhaul link 75 in the absence of the control link 70 can be associated to a time domain resource configured to the repeater access beam.

In a particular embodiment, the indication of the TCI state can be transmitted by one or more of, for example:
a) RRC;
b) MAC CE;
c) Downlink Control Information (DCI);
d) . . .

In a particular embodiment, the MAC CE indicating a TCI state contains a field indicating one or more of:
a) the indicated TCI state should be activated/deactivated only for the control link 70;
b) the indicated TCI state should be activated/deactivated only for the backhaul link 75; and/or
c) the indicated TCI state should be activated/deactivated for both the control link 70 and the backhaul link 75.

In a particular embodiment, the DCI indicating a TCI state contains a field indicating one or more of:
a) the indicated TCI state should be activated only for the control link 70;
b) the indicated TCI state should be activated only for the backhaul link 75; and/or
c) the indicated TCI state should be activated for both the control link 70 and backhaul link 75.

In a particular embodiment, the DCI indicating a TCI state can be included in one or more of:
a) a legacy DCI format; and
b) a new repeater node specific DCI format.

In a particular embodiment, the time resource contains both a starting time and an ending time. In another particular embodiment, the time resource contains only a starting time and has no ending time. In still another embodiment, the time resource contains a starting time and a duration.

In a particular embodiment, the indication of the TCI state is received by repeater-MT 60.

In a particular embodiment, the set of candidate TCI states for repeater backhaul link beams is RRC configured to the repeater node 55 as a list of RRC information elements or one RRC information element.

In a particular embodiment, the set of candidate TCI states for repeater backhaul link beams is in the same RRC information element as the semi-static configurations for the access link beams.

In a particular embodiment, the set of candidate TCI states for repeater backhaul link beams is in the same RRC information element as the legacy semi-static configurations for repeater-MT 60.

In a particular embodiment, the signalling of the indication of the TCI state (1c) includes a pointer to one of the TCI states in the higher layer configured set of candidate TCI states.

In a particular embodiment, the higher layer configured set of candidate TCI states is per sub-band.

In a particular embodiment, the higher layer configured set of candidate TCI states is common for multiple sub-bands.

In a particular embodiment, the collision of multiple beam indications on the same time resource can be solved following collision handling rules.

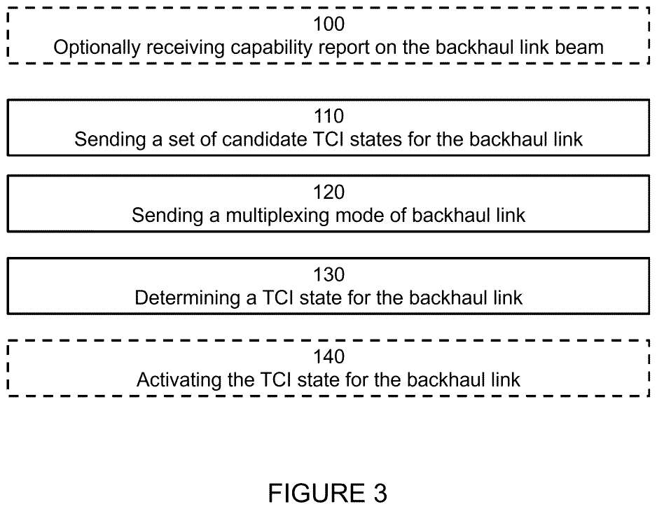

FIG. 3 illustrates an example method for simultaneous operation of the control and backhaul links, according to certain embodiments. More specifically, FIG. 3 illustrates time domain multiplexing of the control link 70 and backhaul link 75.

In the depicted example method of FIG. 3, the controlling network node 110 (e.g., gNB) receives a capability report on the backhaul link beam, in an optional step 100. Thus, the repeater node 55 optionally reports to the controlling network node 110 about its capabilities regarding the backhaul link beams. According to various particular embodiments, the capability report, may include and/or indicate one or more of:
support of simultaneous transmission and/or reception of the control link 70 and backhaul link 75;
support of simultaneous down-link(DL) and/or up-link(UL) of the control link 70 and backhaul link 75;
support of adaptive beamforming of control link 70 and/or backhaul link 75;
support of dynamic indication of flexible symbols;
an explicit backhaul beam indication;
. . .

At step 110, the network node 110 configures and/or sends a set of candidate TCI states for the backhaul link 75. In particular embodiments, the set of candidate TCI states is based on one or more of:
the reported capabilities of the repeater node 55 (e.g., adaptive beamforming of backhaul link 75);
the measurement result from repeater-MT 60 (e.g., P1/P2 beam sweeping as described above);
. . .

According to various particular embodiments, the determination of the set of the candidate TCI states is based on one or more of:
received signal quality at the repeater node 55 (e.g., received power level (RSRP), Signal to Noise Ratio (SNR), Reference Signal Received Quality (RSRQ), etc.);
self-interference level with respect to one or more access link beams at the repeater node 55;
average performance at the repeater node 55 with respect to signal level and interference level;
interference level at the wireless network node 110;
interference level at the repeater node 55;
network traffic condition;

The set of candidate TCI can contain TCI states for simultaneous operation of backhaul link 75 and control link 70, and TCI states for the operation of the backhaul link 75 only.

In a particular embodiment, the set of candidate TCI states for repeater backhaul link 75 is RRC configured to the repeater node 55 as a list of RRC information elements or one RRC information element.

In a particular embodiment, the set of candidate TCI states for repeater backhaul link 75 is in the same RRC information element as the semi-static configuration for the access link beams.

In another particular embodiment, the set of candidate TCI states for repeater backhaul link is in the same RRC information element as the semi-static configuration for the repeater MT beams for the control link 70.

At step 120, the network node 110 determines and sends the multiplexing operational mode of the backhaul link 75 for a certain time resource. For example, the network node 110 may send an indication of whether the backhaul link 75 operates simultaneously with the control link 70, and/or in the absence of control link 70, as at least one of:
simultaneous operation with the control link 70 (e.g., DL and/or UL);
time domain multiplexing with the control link 70 (e.g., DL and/or UL);
frequency domain multiplexing with the control link 70 (e.g., DL and/or UL);
. . .

In a particular embodiment, the simultaneous operation comprises of one or more of:
simultaneous transmission of the backhaul link 75 and control link 70;
simultaneous reception of the backhaul link 75 and control link 70;
. . .

In various particular embodiments, the determination of the multiplexing operational mode of the backhaul link 75 can be based on one or more of:
a reported repeater backhaul beam capability;
a network traffic condition such as, for example, a high versus a low network load;
a TDD UL/DL pattern (e.g., fewer UL resources implies different scheduling needs);
a self-interference level such as, for example, with respect to one or more access link beams;
a network interference level;
an energy saving mode of the repeater-MT 60 (e.g., the DRX configuration, etc.);
a need to schedule repeater-MT 60 and UE 112 at the same time such as, for example, due to coinciding PDCCH time resource configurations;
a need of side control information for the repeater node 55 such as, for example, to update the dynamic indication of the repeater-Fwd 65;
a need of ACK/NACK for the repeater node 55 or UE 112 for coinciding PUCCH time resource configurations
. . .

In a particular embodiment, the determined multiplexing mode of the backhaul link 75 is informed to the repeater node 55 at least via the side control information and its associated time domain resource configuration. In one example, the repeater node 55 can determine the multiplexing mode of the backhaul link 75 by assessing if a time resource is provided with both configurations for the control link 70 and backhaul link 75, or only one of the two configurations. In an alternative embodiment, the determined multiplexing mode of the backhaul link 75 can be informed to the repeater node 55 using an explicit signaling.

In a particular embodiment, the determined multiplexing mode of the backhaul link 75 is associated to a time resource where the time resource can contain both a starting time and an ending time, or only a starting time but no ending time, or a starting time and a duration.

At step 130, upon determining the absence of the control link 70, the network node 110 determines a TCI state for the backhaul link 75. In a particular embodiment, for example, the determination of backhaul beam can be based on and/or include one or more of:
following a predefined rule or specification;
interference level with respect to a determined access beam;
a new backhaul beam indication (e.g., an explicit backhaul beam indication) based on measurement from repeater-MT;
. . .

Some examples of predefined rules can be one or more of:
a default backhaul beam;
the (most) recently indicated beam for the repeater control link 70, where a beam may further be divided into a specific beam type:
   narrow beam (e.g., CSI-RS); and
   wide beam (e.g., SSB).
. . .

At an optional step 140, the network node 110 activates or deactivates a new TCI state for the backhaul link 75 based on the decision from step 130 by sending an activating/deactivating message.

In a particular embodiment, the activation and deactivation of the TCI state for backhaul beams can be conveyed by for example, RRC signaling, MAC CE signaling, or DCI signaling. In another particular embodiment, the activation and/or deactivation of the TCI state for the backhaul beams are received by repeater-MT 60 via the side control information.

In a particular embodiment, the MAC CE activation/deactivation signaling contains a field indicating one or more of:
the indicated TCI state should be activated/deactivated only for the control link 70;
the indicated TCI state should be activated/deactivated only for the backhaul link 75; and/or
the indicated TCI state should be activated/deactivated for both the control link 70 and the backhaul link 75.

In a particular embodiment, the activation signaling means the indicated TCI state is valid until further notification such as, for example, when deactivation signaling is received.

In another particular embodiment, the DCI signaling contains a field indicating one or more of:
the indicated TCI state should be activated/deactivated only for the control link 70;
the indicated TCI state should be activated/deactivated only for the backhaul link 75; and/or
the indicated TCI state should be activated/deactivated for both the control link 70 and the backhaul link 75.

In a related embodiment, the DCI signaling can be included in, for example, at least one of:
a legacy DCI format; and/or
a new repeater node specific DCI format

In a particular embodiment, the TCI state indication of the backhaul beam is associated to and applied to the time domain resource configuration of the access beam indication. In an alternative, the TCI state indication of a backhaul beam is provided with a separate time domain resource configuration from the access beam indication.

In a particular embodiment, the signaling of the TCI state indication includes a pointer to one of the TCI states in the higher layer configured set of candidate TCI states.

In a particular embodiment, the TCI states configured specifically for the backhaul beams can be a subset of the TCI states configured for simultaneous operation of the control link 70 and backhaul link 75. In another alternative, the TCI states configured specifically for the backhaul beams can partially overlap with the set of TCI states configured for simultaneous operation of the control link 70 and backhaul link 75.

In a particular embodiment, the higher layer configured set of candidate backhaul beam TCI states is per sub-band. In an alternative embodiment, the higher layer configured set of candidate backhaul beam TCI states is common for multiple sub-bands.

In a particular embodiment, the collision of multiple beam indication of the same time resource can be solved following collision handling rules, for example a later received indication overrides the previously received indication.

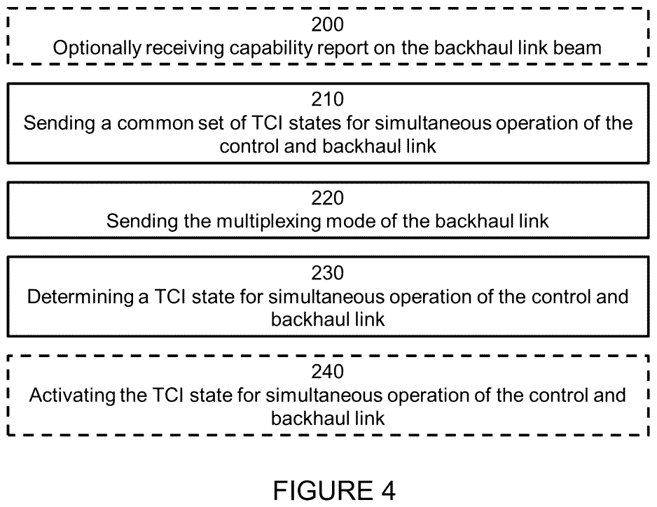

FIG. 4 illustrates another example method for simultaneous operation of control link and backhaul link 75, according to certain embodiments. Specifically, FIG. 4 illustrates time domain multiplexing of the control link 70 and backhaul link 75.

As depicted in FIG. 4, and in an optional step 200, the controlling network node receives a capability report on the backhaul link beam. For example, the repeater node 55 may report to the controlling network node 110 about its capabilities regarding the backhaul link 75. In a particular embodiment, for example, the capability report may include and/or indicate one or more of:
support of simultaneous transmission and/or reception of the control link 70 and backhaul link 75;
support of simultaneous DL and/or UL of the control link 70 and backhaul link 75;
support of adaptive beamforming of control link 70 and/or backhaul link 75;
. . .

At step 210, the network node 110 configures and sends a set of common TCI states for the control link 70 and backhaul link 75. In a particular embodiment, the set of common TCI states is based on one or more of:
the reported capabilities of the repeater node 55 (e.g., adaptive beamforming of control link 70 and backhaul link 75),
the measurement result from repeater-MT 60 (e.g., P1/P2 beam sweeping as described above)
. . .

In particular embodiments, the determination of the set of TCI states common for the simultaneous operation of control link 70 and backhaul link 75 is based on one or more of:
received signal quality (e.g., received power level, SNR, etc.);
self-interference level with respect to access link beams;
average performance with respect to signal level and interference level;
interference level at the wireless network node 110;
interference level at the repeater node 55;
network traffic condition;
. . .

At step 220, the network node 110 determines and sends the multiplexing mode of a certain time resource with respect to whether the backhaul link 75 operates simultaneously with the control link 70, or in absence of control link 70:
Simultaneous operation with the control link 70 (e.g., DL and/or UL);
Time domain multiplexing with the control link 70 (e.g., DL and/or UL);
frequency domain multiplexing with the control link 70 (e.g., DL and/or UL);
. . .

In a particular embodiment, the determined multiplexing mode of the backhaul link 75 is informed to the repeater node 55 at least via the side control information.

In another particular embodiment, the determined multiplexing mode of the backhaul link is associated to a time resource, and the time resource can contain both a starting time and an ending time, or only a starting time but no ending time, or a starting time and a duration.

At step 230, upon determining simultaneous operation of the control link 70 and backhaul link 75, the network node 110 determines a TCI state for the simultaneous operation of the control link 70 and backhaul link 75.

In various particular embodiments, the determination of the multiplexing mode of the backhaul link 75 is based on one or more of:
a reported repeater backhaul beam capability;
a network traffic condition;
a TDD UL/DL pattern;
a self-interference level such as, for example, with respect to the access link beams;
a network interference level;
an energy saving mode of the repeater-MT 60 (e.g., the DRX configuration, etc.);
a need to scheduling repeater-MT 60 and UE 112 at the same time;
a need of side control information for the repeater node 55;
a need of ACK/NACK for the repeater node 55 or UEs 112;
. . .

According to particular embodiments, the determination of the shared beam for simultaneous operation of the backhaul link 75 and control link 70 includes of one or more of:
a preferred control link beam in terms of, for example, received power, and/or interference condition (e.g., SINR), etc;
a preferred backhaul link beam in terms of, for example, received power, and/or interference condition (e.g., SINR), etc;
average performance with respect to both control link 70 and backhaul link 75 in terms of, for example, received power level and interference level, etc;
a recently indicated beam for the repeater-control link 70;
a recently indicated beam for the backhaul link 75;

At an optional step 240, the network node 110 activates a new TCI state for the simultaneous operation of the control link 70 and backhaul link 75, based on the decision from step 220, by sending an activating/deactivating message.

In a particular embodiment, the TCI state indication is associated to a certain signals and channels configured to the repeater-MT 60 such as, for example, PDSCH, PDCCH, PUSCH, PUCCH, etc.

In a particular embodiment, the activation and deactivation of the TCI state for backhaul beams can be conveyed by for example, RRC signaling, MAC CE signaling, or DCI signaling. In a particular embodiment, the activation and/or deactivation of the TCI state for the backhaul beams are received by repeater-MT 60 via the side control information.

In a particular embodiment, the MAC CE activation/deactivation signaling contains a field indicating one or more of:
the indicated TCI state should be activated/deactivated only for the control link 70;
the indicated TCI state should be activated/deactivated only for the backhaul link 75; and/or
the indicated TCI state should be activated/deactivated for both the control link 70 and the backhaul link 75.

In another particular embodiment, the DCI signaling contains a field indicating one or more of:
the indicated TCI state should be activated only for the control link 70;
the indicated TCI state should be activated only for the backhaul link 75;
the indicated TCI state should be activated for both the control link 70 and the backhaul link 75;
. . .

In a further particular embodiment, the DCI signaling is:
a legacy DCI format; and/or
a new repeater node specific DCI format

In a particular embodiment, the set of candidate TCI states for simultaneous operation of the control link 70 and backhaul link 75 is RRC configured to the repeater node 55 as a list of RRC information elements or one RRC information elements.

In a particular embodiment, the set of candidate TCI states for simultaneous operation of the control link 70 and backhaul link 75 is in the same RRC information element as the semi-static configuration for the access link beams.

In an alternative particular embodiment, the set of candidate TCI states for simultaneous operation of the control link 70 and backhaul link 75 is in the same RRC information element as the semi-static configuration for the repeater MT beams. In another alternative particular embodiment, the set of candidate TCI states for simultaneous operation of the control link 70 and backhaul link 75 is the same set of TCI states configured to repeater MT beams.

In a particular embodiment, the signaling of the TCI state indication includes a pointer to one of the TCI states in the higher layer configured set of candidate TCI states.

In a particular embodiment, the higher layer configured set of candidate TCI states for simultaneous operation of the control link 70 and backhaul link 75 is per sub-band. In an alternative particular embodiment, the higher layer configured set of candidate TCI states for simultaneous operation of the control link 70 and backhaul link 75 is common for multiple sub-bands.

In a particular embodiment, the collision of multiple beam indication of the same time resource can be solved following collision handling rules, for example a later received indication overrides the previously received indication.

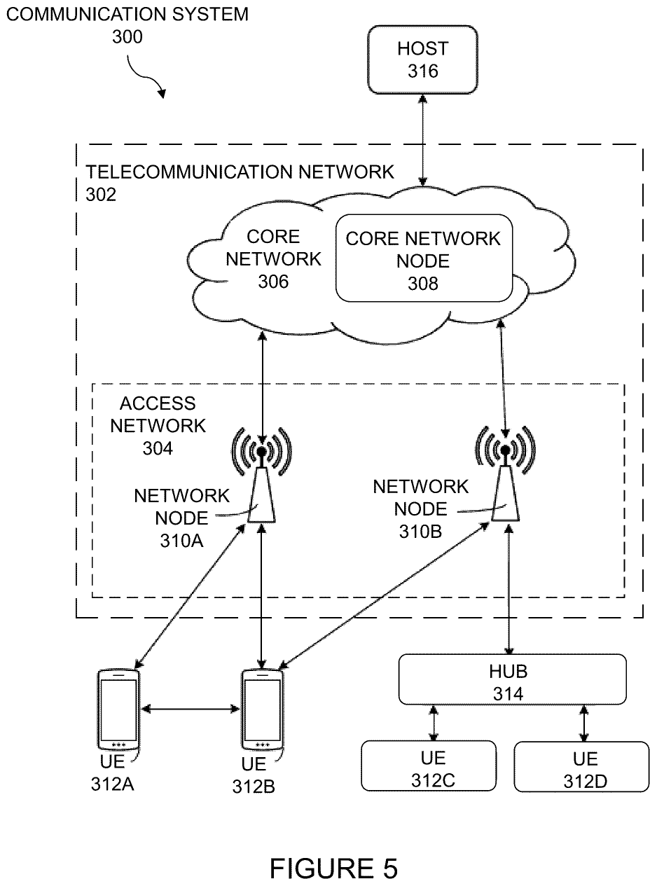

FIG. 5 shows an example of a communication system 300 in accordance with some embodiments. In the example, the communication system 300 includes a telecommunication network 302 that includes an access network 304, such as a radio access network (RAN), and a core network 306, which includes one or more core network nodes 308. The access network 304 includes one or more access network nodes, such as network nodes 310a and 310b (one or more of which may be generally referred to as network nodes 310), or any other similar 3^{rd} Generation Partnership Project (3GPP) access node or non-3GPP access point. The network nodes 310 facilitate direct or indirect connection of user equipment (UE), such as by connecting UEs 312a, 312b, 312c, and 312d (one or more of which may be generally referred to as UEs 312) to the core network 306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 302 is a cellular network that implements 3GPP standardized features. Accordingly, the telecommunications network 302 may support network slicing to provide different logical networks to different devices that are connected to the telecommunication network 302. For example, the telecommunications network 302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 314 communicates with the access network 304 to facilitate indirect communication between one or more UEs (e.g., UE 312c and/or 312d) and network nodes (e.g., network node 310b). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a VR headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular in if one or more of the UEs are low energy IoT devices.

The hub 314 may have a constant/persistent or intermittent connection to the network node 310b. The hub 314 may also allow for a different communication scheme and/or schedule between the hub 314 and UEs (e.g., UE 312c and/or 312d), and between the hub 314 and the core network 306. In other examples, the hub 314 is connected to the core network 306 and/or one or more UEs via a wired connection. Moreover, the hub 314 may be configured to connect to an M2M service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub-that is, a hub whose primary function is to route communications to/from the UEs from/to the network node 310b. In other embodiments, the hub 314 may be a non-dedicated hub-that is, a device which is capable of operating to route communications between the UEs and network node 310b, but which is additionally capable of operating as a communication start and/or end point for certain data channels.

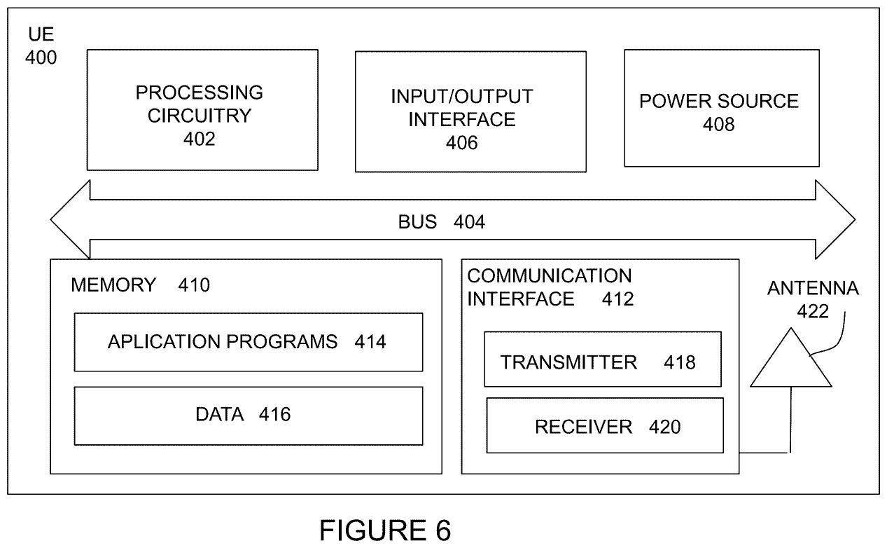

FIG. 6 shows a UE 400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, a memory 410, a communication interface 412, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 402 may include multiple central processing units (CPUs).

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging of the power source 408. Power circuitry may perform any formatting, converting, or other modification to the power from the power source 408 to make the power suitable for the respective components of the UE 400 to which power is supplied.

The memory 410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 410 may allow the UE 400 to access instructions, application programs and the like, stored on transitory or non-transitory memory media, to off-load data, or to upload data. An article of manufacture, such as one utilizing a communication system may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., antenna 422) and may share circuit components, software or firmware, or alternatively be implemented separately.

In the illustrated embodiment, communication functions of the communication interface 412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 400 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

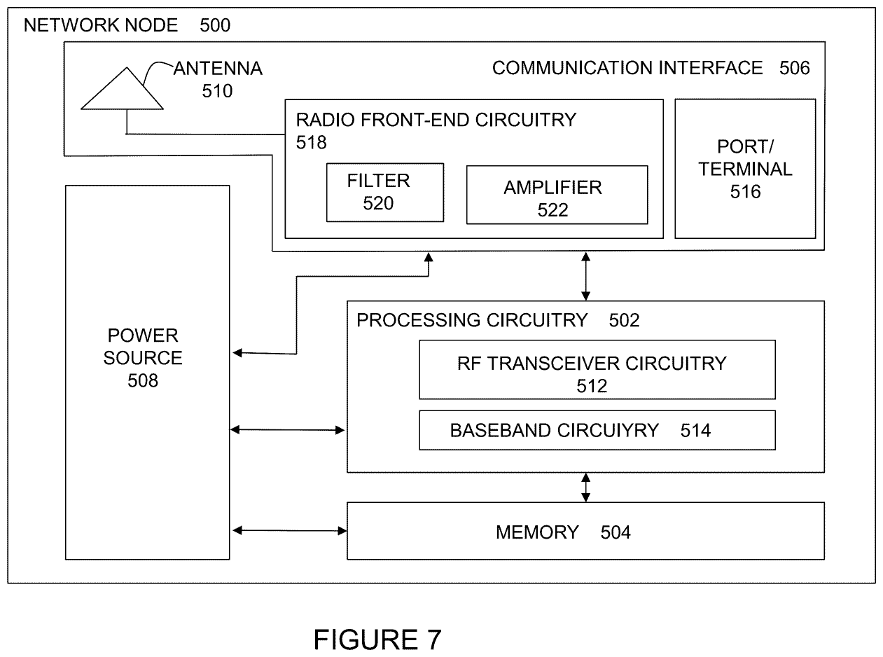

FIG. 7 shows a network node 500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 500 includes a processing circuitry 502, a memory 504, a communication interface 506, and a power source 508. The network node 500 may be composed of multiple physically separate components (e.g., a NodeB component and a RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 500 may be configured to support multiple radio access technologies (RATs). In such embodiments, some components may be duplicated (e.g., separate memory 504 for different RATs) and some components may be reused (e.g., a same antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 500.

The processing circuitry 502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 500 components, such as the memory 504, to provide network node 500 functionality.

In some embodiments, the processing circuitry 502 includes a system on a chip (SOC). In some embodiments, the processing circuitry 502 includes one or more of radio frequency (RF) transceiver circuitry 512 and baseband processing circuitry 514. In some embodiments, the radio frequency (RF) transceiver circuitry 512 and the baseband processing circuitry 514 may be on separate chips (or sets of chips), boards, or units, such as radio units and digital units. In alternative embodiments, part or all of RF transceiver circuitry 512 and baseband processing circuitry 514 may be on the same chip or set of chips, boards, or units.

The memory 504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and memory 504 is integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510. Radio front-end circuitry 518 comprises filters 520 and amplifiers 522. The radio front-end circuitry 518 may be connected to an antenna 510 and processing circuitry 502. The radio front-end circuitry may be configured to condition signals communicated between antenna 510 and processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of filters 520 and/or amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface may comprise different components and/or different combinations of components.

In certain alternative embodiments, the network node 500 does not include separate radio front-end circuitry 518, instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes one or more ports or terminals 516, the radio front-end circuitry 518, and the RF transceiver circuitry 512, as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, communication interface 506, and/or the processing circuitry 502 may be configured to perform any receiving operations and/or certain obtaining operations described herein as being performed by the network node. Any information, data and/or signals may be received from a UE, another network node and/or any other network equipment. Similarly, the antenna 510, the communication interface 506, and/or the processing circuitry 502 may be configured to perform any transmitting operations described herein as being performed by the network node. Any information, data and/or signals may be transmitted to a UE, another network node and/or any other network equipment.

The power source 508 provides power to the various components of network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid, an electricity outlet) via an input circuitry or interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 7 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

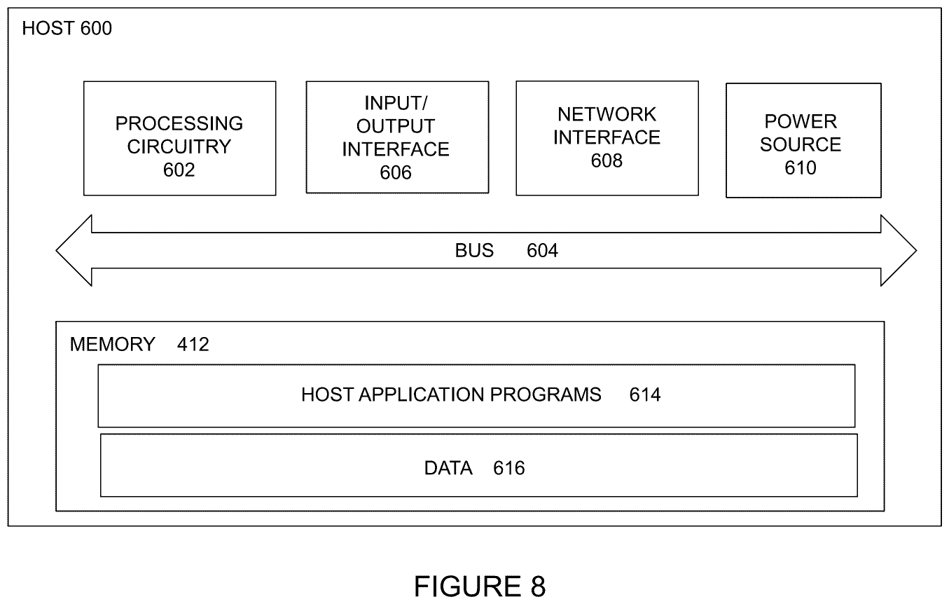

FIG. 8 is a block diagram of a host 600, which may be an embodiment of the host 316 of FIG. 5, in accordance with various aspects described herein. As used herein, the host 600 may be or comprise various combinations hardware and/or software, including a standalone server, a blade server, a cloud-implemented server, a distributed server, a virtual machine, container, or processing resources in a server farm. The host 600 may provide one or more services to one or more UEs.

The host 600 includes processing circuitry 602 that is operatively coupled via a bus 604 to an input/output interface 606, a network interface 608, a power source 610, and a memory 612. Other components may be included in other embodiments. Features of these components may be substantially similar to those described with respect to the devices of previous figures, such as FIGS. 4 and 5, such that the descriptions thereof are generally applicable to the corresponding components of host 600.

The memory 612 may include one or more computer programs including one or more host application programs 614 and data 616, which may include user data, e.g., data generated by a UE for the host 600 or data generated by the host 600 for a UE. Embodiments of the host 600 may utilize only a subset or all of the components shown. The host application programs 614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 614 may also provide for user authentication and licensing checks and may periodically report health, routes, and content availability to a central node, such as a device in or on the edge of a core network. Accordingly, the host 600 may select and/or indicate a different host for over-the-top services for a UE. The host application programs 614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

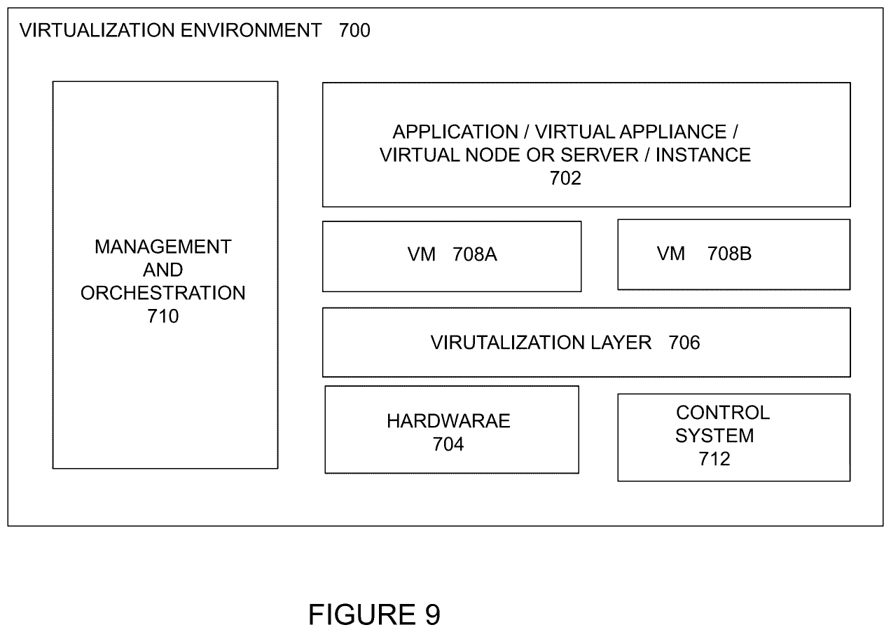

FIG. 9 is a block diagram illustrating a virtualization environment 700 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 702 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 712 which may alternatively be used for communication between hardware nodes and radio units.

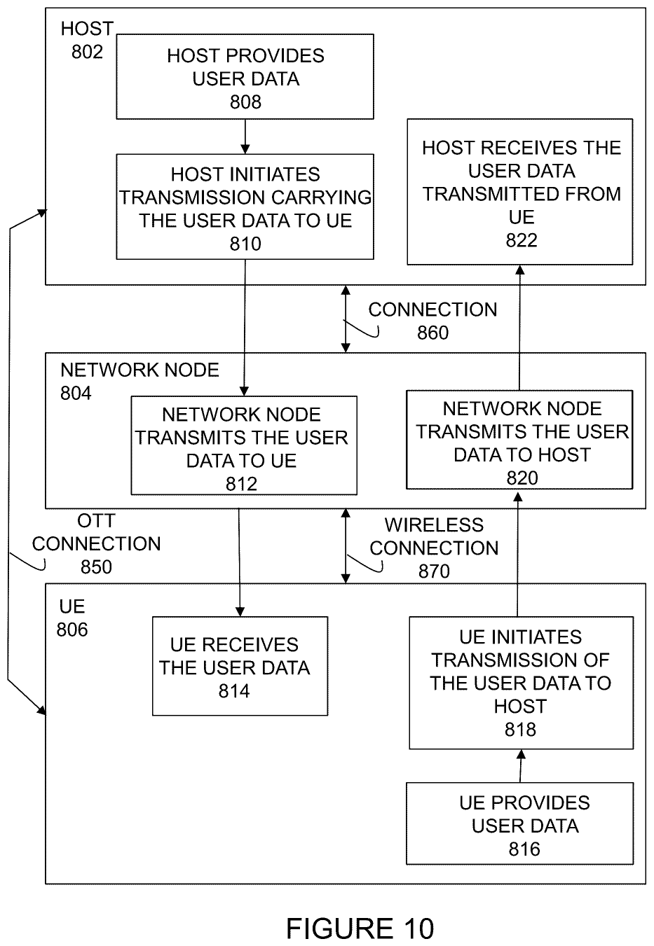

FIG. 10 shows a communication diagram of a host 802 communicating via a network node 804 with a UE 806 over a partially wireless connection in accordance with some embodiments.

Example implementations, in accordance with various embodiments, of the UE (such as a UE 312a of FIG. 5 and/or UE 400 of FIG. 6), network node (such as network node 310a of FIG. 5 and/or network node 500 of FIG. 7), and host (such as host 316 of FIG. 5 and/or host 600 of FIG. 8) discussed in the preceding paragraphs will now be described with reference to FIG. 10.

Like host 600, embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 306 of FIG. 5) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio, VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes; the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings, preferred routing etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

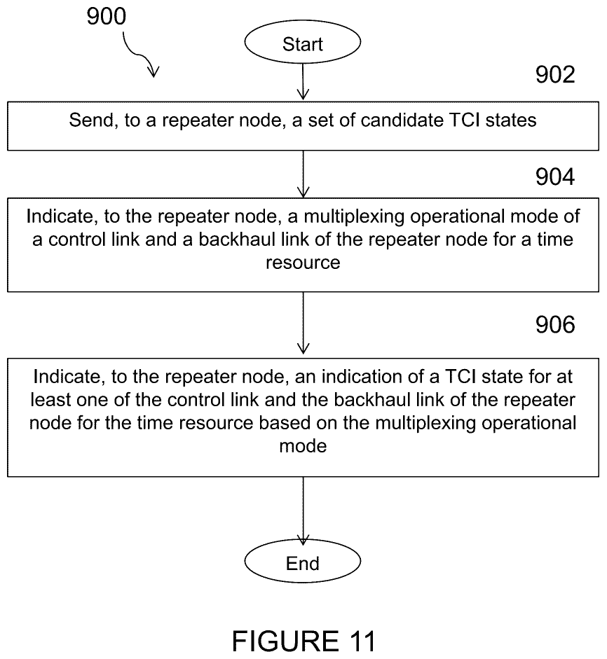

FIG. 11 illustrates a method 900 by a network node 110 for operation of a control link 70 and/or backhaul link 75, according to certain embodiments. The method includes sending, to a repeater node 55, a set of candidate TCI states, at step 902. The network node 110 indicates, to the repeater node 55, a multiplexing operational mode of a control link 70 and a backhaul link 75 of the repeater node 55 for a time resource, at step 904. At step 906, the network node 110 indicates, to the repeater node 55, an indication of a TCI state for at least one of the control link 70 and the backhaul link 75 of the repeater node 55 for the time resource based on the multiplexing operational mode.

In a particular embodiment, the network node 110 receives, from the repeater node 55, a backhaul link beam capability report, which includes at least one of: an indication that the repeater node 55 supports simultaneous transmission and/or reception of the control link 70 and the backhaul link 75; and an indication that the repeater node 55 supports adaptive beamforming of the control link 70 and/or the backhaul link 75.

In a particular embodiment, the set of candidate TCI states includes: at least one candidate TCI state for simultaneous operation of the backhaul link 75 and the control link 70; and at least one candidate TCI state for the operation of the backhaul link 75 only.

In a particular embodiment, the multiplexing operational mode of the control link 70 and the backhaul link 75 comprises at least one of: simultaneous operation with the control link 70 in at least one of a downlink direction and an uplink direction; and time domain multiplexing with the control link 70 in at least one of the downlink direction and the uplink direction.

In a further particular embodiment, the multiplexing operational mode is indicated implicitly. For example, in a first example embodiment, the control link 70 is scheduled by first scheduling a PDSCH through information is an earlier PDCCH reception, or a PDCCH decoding time resource. Then, the backhaul link is scheduled through an access link indication by either a periodic/semi-persistent configuration or an aperiodic dynamic indication. Alternatively, in a second example embodiment, the backhaul link is first scheduled (through an access link indication) by either a periodic/semi-persistent configuration and then the control link is scheduled dynamically through, for example, a scheduling DCI.

In a particular embodiment, the network node 110 determines the multiplexing operational mode of the control link 70 and the backhaul link 75 based on at least one of: a reported backhaul beam capability of the repeater node 55; a TDD pattern for at least one of an uplink and a downlink; a network interference level; an energy saving mode of a MT 60 of the repeater node 55; a need of an ACK and/or NACK to or from the repeater node 55 and/or to or from at least one UE 112.

In a particular embodiment, the indication of the TCI state is based on at least one of: an indicated beam for the control link 70; and an indicated beam for the backhaul link 75.

In a further particular embodiment, the indicated beam for the control link 70 and/or the indicated beam for the backhaul link 75 is determined based on at least one of: a control link beam quality; and a backhaul link beam quality.

In a particular embodiment, the time resource of the TCI state for simultaneous operation of the backhaul link 75 and control link 70 can be associated to a signal or a channel configured to a MT 60 of the repeater node 55.

In a particular embodiment, in the absence of a transmission and/or reception on the control link 70, the indication of the TCI state for the backhaul link 75 is based on at least one of: a default backhaul beam; a predefined rule or specification; an indicated TCI state for the repeater control link 70; and a dedicated backhaul beam indication based on measurement from the repeater node 55.

In a particular embodiment, in the absence of a transmission and/or reception on the control link 70, the time resource for the TCI state for the backhaul link 75 is associated to a time domain resource configured to an access beam of a repeater-forward 65.

In a particular embodiment, the indication of the TCI state is transmitted via at least one of: a RRC signal; a MAC CE; and DCI.

In a particular embodiment, the MAC CE indicating the TCI state contains a field indicating that the TCI state should be activated or deactivated only for the backhaul link 75.

In a particular embodiment, the set of candidate TCI states is for repeater backhaul link beams and is in a same RRC information element that provides at least one semi-statically configured TCI list for a MT 60 of the repeater node 55.

In a particular embodiment, the indication of the TCI state comprises a pointer to a TCI state in the set of candidate TCI states.

In particular embodiments, the set of candidate TCI states is per sub-band or the set of candidate TCI states is common for multiple sub-bands.

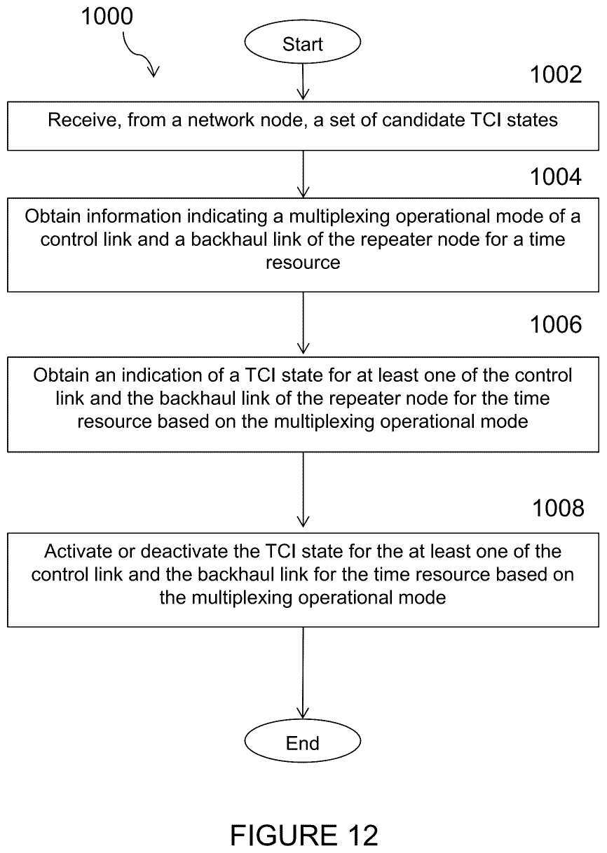

FIG. 12 illustrates a method 1000 by a repeater node 55 for operation of a control link 70 and/or backhaul link 75, according to certain embodiments. At step 1002, the repeater node 55 receives, from a network node 110, a set of candidate TCI states. At step 1004, the repeater node 55 obtains information indicating a multiplexing operational mode of a control link 70 and a backhaul link 75 of the repeater node 55 for a time resource. At step 1006, the repeater node 55 obtains an indication of a TCI state for at least one of the control link 70 and the backhaul link 75 of the repeater node 55 for the time resource based on the multiplexing operational mode. At step 1008, the repeater node 55 activates or deactivates the TCI state for the at least one of the control link 70 and the backhaul link 75 for the time resource based on the multiplexing operational mode.

In a particular embodiment, the repeater node 55 transmits, to the network node 110, a backhaul link beam capability report. The backhaul link beam capability report includes at least one of: an indication that the repeater node 55 supports simultaneous transmission and/or reception of the control link 70 and the backhaul link 75; and an indication that the repeater node 55 supports adaptive beamforming of the control link 70 and/or the backhaul link 75.

In a particular embodiment, the set of candidate TCI states includes at least one candidate TCI state for simultaneous operation of the backhaul link 75 and the control link 70, and at least one candidate TCI state for the operation of the backhaul link 75 only.

In a particular embodiment, the multiplexing operational mode of the control link 70 and the backhaul link 75 comprises at least one of: simultaneous operation with the control link 70 in at least one of a downlink direction and an uplink direction; and time domain multiplexing with the control link 70 in at least one of the downlink direction and the uplink direction.

In a particular embodiment, the multiplexing operational mode is indicated implicitly. For example, in a first example embodiment, the control link 70 is scheduled by first scheduling a PDSCH through information is an earlier PDCCH reception, or a PDCCH decoding time resource. Then, the backhaul link is scheduled through an access link indication by either a periodic/semi-persistent configuration or an aperiodic dynamic indication. Alternatively, in a second example embodiment, the backhaul link is first scheduled (through an access link indication) by either a periodic/semi-persistent configuration and then the control link is scheduled dynamically through, for example, a scheduling DCI.

In a particular embodiment, when obtaining the information indicating the multiplexing operational mode of the control link 70 and the backhaul link 75, the repeater node 55 determines the multiplexing operational mode based on at least one of: a reported backhaul beam capability of the repeater node 55; a TDD pattern for at least one of an uplink and a downlink; a network interference level; an energy saving mode of a MT 60 of the repeater node 55; and a need of an ACK and/or NACK to or from the repeater node 55 and/or to or from at least one UE 112.

In a particular embodiment, the indication of the TCI state is based on at least one of: an indicated beam for the control link 70; and an indicated beam for the backhaul link 75.

In a further particular embodiment, the indicated beam for the control link 70 and/or the indicated beam for the backhaul link 75 is determined based on at least one of: a control link beam quality; and a backhaul link beam quality.

In a particular embodiment, the time resource of the TCI state for simultaneous operation of the backhaul link 75 and control link 70 is associated to a signal or a channel configured to a MT 60 of the repeater node 55.

In a particular embodiment, in an absence of a transmission and/or reception on the control link 70, the indication of the TCI state for the backhaul link 75 is based on at least one of: a default backhaul beam; a predefined rule or specification; an indicated TCI state for the repeater control link 70; and a dedicated backhaul beam indication based on measurement from the repeater node 55.

In a particular embodiment, in the absence of a transmission and/or reception on the control link 70, the time resource for TCI state for the backhaul link 75 is associated to a time domain resource configured to an access beam of a repeater-forward 65.

In a particular embodiment, obtaining the indication of the TCI state is received via at least one of: a RRC signal; a MAC CE; and DCI.

In a further particular embodiment, the MAC CE indicates the TCI state contains a field indicating that the TCI state should be activated or deactivated only for the backhaul link 75.

In a particular embodiment, the set of candidate TCI states is for repeater backhaul link beams and is in a same RRC information element that provides at least one semi-statically configured TCI list for a MT 60 of the repeater node 55.

In a particular embodiment, obtaining the indication of the TCI state includes receiving a pointer to a TCI state in the set of candidate TCI states.

In a particular embodiment, the set of candidate TCI states is per sub-band, or the set of candidate TCI states is common for multiple sub-bands.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a network node for operation of control and/or backhaul links, the method comprising: sending, to a repeater node, a set of candidate TCI states; sending, to the repeater node, a multiplexing operational mode for at least one of a control link and a backhaul link of the repeater node for a time resource; and sending, to the repeater node, an indication activating or deactivating a TCI state for at least one of the control link and the backhaul link of the repeater node for the said time resource based on the multiplexing operational mode.

Example Embodiment C2. The method of Example Embodiment C1, comprising receiving from the repeater node a backhaul link beam capability report, wherein the backhaul link beam capability report comprises at least one of: an indication of support of simultaneous transmission and/or reception of the control link and the backhaul link; an indication of support of simultaneous DL and/or UL of the control link and the backhaul link; and an indication of support of adaptive beamforming of the control link and/or the backhaul link.

Example Embodiment C3. The method of any one of Example Embodiments C1 to C2, comprising determining, by the network node, the set of candidate TCI states for the control and/or backhaul link beams, based on at least one of: a received signal quality (e.g., received power level, SNR); a self-interference level with respect to access link beams; an averaged performance with respect to signal level and interference level; an interference level at the wireless network node; an interference level at the repeater node; and/or a network traffic condition.

Example Embodiment C4. The method of any one of Example Embodiments C1 to C3, wherein the set of candidate TCI states comprises at least one TCI state for simultaneous operation of backhaul and control-link and at least one TCI state for the operation of the backhaul link only.

Example Embodiment C5. The method of any one of Example Embodiments C1 to C4, wherein the multiplexing operational mode of the backhaul link comprises at least one of: simultaneous operation with the control link, e.g., DL and/or UL; time domain multiplexing with the control link, e.g., DL and/or UL; and frequency domain multiplexing with the control link, e.g., DL and/or UL.

Example Embodiment C6a. The method of Example Embodiment C5, wherein the multiplexing operational mode is indicated implicitly.

Example Embodiment C6b. The method of Example Embodiment C5, wherein the multiplexing operational mode is indicated explicitly.

Example Embodiment C7. The method of any one of Example Embodiments C1 to C6b, comprising determining the multiplexing operational mode of the backhaul link based on at least one of: a reported repeater node backhaul beam capability; a network traffic condition; a TDD UL/DL pattern; a self-interference level; a network interference level; an energy saving mode of the repeater-MT (e.g., the DRX configuration etc.); a need of side control information for the repeater node; and a need of ACK/NACK for the repeater node or at least one UE.

Example Embodiment C8. The method of any one of Example Embodiments C1 to C7, wherein the indication of the TCI state is based on at least one of: a preferred control link beam in terms of e.g., received power level, or interference condition (SINR) etc; a preferred backhaul link beam in terms of e.g., received power level, or interference condition (SINR) etc; an averaged performance for both control and backhaul links in term of signal level and interference/noise level; a recently indicated beam for the repeater control link; and a recently indicated beam for the backhaul link.

Example Embodiment C9. The method of any one of Example Embodiments C1 to C8, wherein the time resource of the TCI state for simultaneous operation of the backhaul and control link can be associated to a signal or a channel configured to a repeater-MT (e.g., such as PDSCH, PDCCH, PUSCH, PUCCH etc).

Example Embodiment C10. The method of any one of Example Embodiments C1 to C9, wherein the indication of the TCI state for the backhaul link in the absence of the control link is based on at least one of: a default backhaul beam; a predefined rule or specification; a recently indicated beam for the repeater control link; an interference level with respect to a determined access beam; and a new backhaul beam indication based on measurement from repeater-MT.

Example Embodiment C11. The method of any one of Example Embodiments C1 to C10, wherein the time resource of the TCI state for the backhaul link in the absence of the control link is associated to a time domain resource configured to the repeater access beam.

Example Embodiment C12. The method of any one of Example Embodiments C1 to C11, wherein the indication of the TCI state is transmitted via at least one of: RRC; MAC CE; and DCI (downlink control information).

Example Embodiment C13. The method of Example Embodiment C12, wherein the MAC CE indicating the TCI state contains a field indicating at least one of: the indicated TCI state should be activated/deactivated only for the control link; the indicated TCI state should be activated/deactivated only for the backhaul link; and the indicated TCI state should be activated/deactivated for both the control link and the backhaul link.

Example Embodiment C14. The method of Example Embodiment C13, wherein the DCI indicating the TCI state is included in a legacy DCI format.

Example Embodiment C15. The method of Example Embodiment C13, wherein the DCI indicating the TCI state is included in a new DCI format.

Example Embodiment C16. The method of any one of Example Embodiments C1 to C15b, wherein the time resource comprises: both a starting time and an ending time, only a starting time but no ending time, or a starting time and a duration.

Example Embodiment C17. The method of any one of Example Embodiments C1 to C16, wherein the indication of the TCI state is sent to a MT of the repeater node.

Example Embodiment C18. The method of any one of Example Embodiments C1 to C17, wherein the set of candidate TCI states is for repeater backhaul link beams and is RRC configured to the repeater node as a list of RRC information elements or one RRC information element.

Example Embodiment C19. The method of any one of Example Embodiments C1 to C18, wherein the set of candidate TCI states is for repeater backhaul link beams and is in the same RRC information element as a semi-static configuration(s) for an access link beam(s).

Example Embodiment C20. The method of any one of Example Embodiments C1 to C19, wherein the set of candidate TCI states is for repeater backhaul link beams and is in the same RRC information element as a legacy semi-static configuration(s) for the MT of the repeater node.

Example Embodiment C21. The method of any one of Example Embodiments C1 to C20, wherein the indication of the TCI state comprises a pointer to one of the TCI states in a higher layer configured set of candidate TCI states.

Example Embodiment C22. The method of Example Embodiment C21, wherein the higher layer configured set of candidate TCI states is per sub-band.

Example Embodiment C23. The method of Example Embodiment C21, wherein the higher layer configured set of candidate TCI states is common for multiple sub-bands.

Example Embodiment C24. The method of any one of Example Embodiments C1 to C23, comprising solving a collision of multiple beam indications on a same time resource based on at least one collision handling rule.

Example Embodiment C25. The method of any one of Example Embodiments C1 to C24, wherein the network node comprises a gNodeB (gNB).

Example Embodiment C26. The method of any of the previous Example Embodiments, further comprising: obtaining user data; and forwarding the user data to a host or a user equipment.

Example Embodiment C27. A network node comprising processing circuitry configured to perform any of the methods of Example Embodiments C1 to C26.

Example Embodiment C28. A computer program comprising instructions which when executed on a computer perform any of the methods of Example Embodiments C1 to C26.

Example Embodiment C29. A computer program product comprising computer program, the computer program comprising instructions which when executed on a computer perform any of the methods of Example Embodiments C1 to C26.

Example Embodiment C30. A non-transitory computer readable medium storing instructions which when executed by a computer perform any of the methods of Example Embodiments C1 to C36.

### Group D Example Embodiments

Example Embodiment D1. A method by a repeater node for operation of control and/or backhaul links, the method comprising: receiving, from a network node, a set of candidate TCI states; receiving, from the network node, a multiplexing operational mode for at least one of a control link and a backhaul link of the repeater node for a time resource; receiving, from the network node, an indication activating or deactivating a TCI state for at least one of the control link and the backhaul link of the repeater node for the said time resource based on the multiplexing operational mode; and activating or deactivating the TCI state for the at least one of the control link and the backhaul link for the time resource based on the multiplexing operational mode.

Example Embodiment D2. The method of Example Embodiment D1, comprising transmitting, to the network node, a backhaul link beam capability report, wherein the backhaul link beam capability report comprises at least one of: an indication of support of simultaneous transmission and/or reception of the control link and the backhaul link; an indication of support of simultaneous DL and/or UL of the control link and the backhaul link; and an indication of support of adaptive beamforming of the control link and/or the backhaul link.

Example Embodiment D3. The method of any one of Example Embodiments D1 to D2, wherein the set of candidate TCI states for the control and/or backhaul link beams is determined based on at least one of: a received signal quality (e.g., received power level, SNR); a self-interference level with respect to access link beams; an averaged performance with respect to signal level and interference level; an interference level at the wireless network node; an interference level at the repeater node; and/or a network traffic condition.

Example Embodiment D4. The method of any one of Example Embodiments D1 to D3, wherein the set of candidate TCI states comprises at least one TCI state for simultaneous operation of backhaul and control-link and at least one TCI state for the operation of the backhaul link only.

Example Embodiment D5. The method of any one of Example Embodiments D1 to D4, wherein the multiplexing operational mode of the backhaul link comprises at least one of: simultaneous operation with the control link, e.g., DL and/or UL; time domain multiplexing with the control link, e.g., DL and/or UL; and frequency domain multiplexing with the control link, e.g., DL and/or UL.

Example Embodiment D6a. The method of Example Embodiment D5, wherein the multiplexing operational mode is indicated implicitly.

Example Embodiment D6b. The method of Example Embodiment D5, wherein the multiplexing operational mode is indicated explicitly.

Example Embodiment D7. The method of any one of Example Embodiments D1 to D6b, wherein the multiplexing operational mode of the backhaul link is determined based on at least one of: a reported repeater node backhaul beam capability; a network traffic condition; a TDD UL/DL pattern; a self-interference level; a network interference level; an energy saving mode of the repeater-MT (e.g., the DRX configuration etc.); a need of side control information for the repeater node; and a need of ACK/NACK for the repeater node or at least one UE.

Example Embodiment D8. The method of any one of Example Embodiments D1 to D7, wherein the indication of the TCI state is based on at least one of: a preferred control link beam in terms of e.g., received power level, or interference condition (SINR) etc; a preferred backhaul link beam in terms of e.g., received power level, or interference condition (SINR) etc; an averaged performance for both control and backhaul links in term of signal level and interference/noise level; a recently indicated beam for the repeater control link; and a recently indicated beam for the backhaul link.

Example Embodiment D9. The method of any one of Example Embodiments D1 to D8, wherein the time resource of the TCI state for simultaneous operation of the backhaul and control link is associated to a signal or a channel configured to a repeater-MT (e.g., such as PDSCH, PDCCH, PUSCH, PUCCH, etc).

Example Embodiment D10. The method of any one of Example Embodiments D1 to D9, wherein the indication of the TCI state for the backhaul link in the absence of the control link is based on at least one of: a default backhaul beam; a predefined rule or specification; a recently indicated beam for the repeater control link; an interference level with respect to a determined access beam; and a new backhaul beam indication based on measurement from repeater-MT.

Example Embodiment D11. The method of any one of Example Embodiments D1 to D10, wherein the time resource of the TCI state for the backhaul link in the absence of the control link is associated to a time domain resource configured to a repeater access beam.

Example Embodiment D12. The method of any one of Example Embodiments D1 to D11, wherein the indication of the TCI state is received via at least one of: RRC; MAC CE; and DCI (downlink control information).

Example Embodiment D13. The method of Example Embodiment D12, wherein the MAC CE indicating the TCI state contains a field indicating at least one of: the indicated TCI state should be activated/deactivated only for the control link; the indicated TCI state should be activated/deactivated only for the backhaul link; and the indicated TCI state should be activated/deactivated for both the control link and the backhaul link.

Example Embodiment D14. The method of Example Embodiment D13, wherein the DCI indicating the TCI state is included in a legacy DCI format.

Example Embodiment D15. The method of Example Embodiment D13, wherein the DCI indicating the TCI state is included in a new DCI format.

Example Embodiment D16. The method of any one of Example Embodiments D1 to D15, wherein the time resource comprises: both a starting time and an ending time, only a starting time but no ending time, or a starting time and a duration.

Example Embodiment D17. The method of any one of Example Embodiments D1 to D16, wherein the indication of the TCI state is received by a MT of the repeater node.

Example Embodiment D18. The method of any one of Example Embodiments D1 to D17, wherein the set of candidate TCI states is for repeater backhaul link beams and is RRC configured to the repeater node as a list of RRC information elements or one RRC information element.

Example Embodiment D19. The method of any one of Example Embodiments D1 to D18, wherein the set of candidate TCI states is for repeater backhaul link beams and is in the same RRC information element as a semi-static configuration(s) for an access link beam(s).

Example Embodiment D20. The method of any one of Example Embodiments D1 to D19, wherein the set of candidate TCI states is for repeater backhaul link beams and is in the same RRC information element as a legacy semi-static configuration(s) for the MT of the repeater node.

Example Embodiment D21. The method of any one of Example Embodiments D1 to D20, wherein the indication of the TCI state comprises a pointer to one of the TCI states in a higher layer configured set of candidate TCI states.

Example Embodiment D22. The method of Example Embodiment D21, wherein the higher layer configured set of candidate TCI states is per sub-band.

Example Embodiment D23. The method of Example Embodiment D21, wherein the higher layer configured set of candidate TCI states is common for multiple sub-bands.

Example Embodiment D24. The method of any one of Example Embodiments D1 to D23, comprising solving a collision of multiple beam indications on a same time resource based on at least one collision handling rule.

Example Embodiment D25. The method of any of the previous Example Embodiments, further comprising: obtaining user data; and forwarding the user data to a host or a user equipment.

Example Embodiment D26. A network node comprising processing circuitry configured to perform any of the methods of Example Embodiments D1 to D25.

Example Embodiment D27. A computer program comprising instructions which when executed on a computer perform any of the methods of Example Embodiments D1 to D25.

Example Embodiment D28. A computer program product comprising computer program, the computer program comprising instructions which when executed on a computer perform any of the methods of Example Embodiments D1 to D25.

Example Embodiment D29. A non-transitory computer readable medium storing instructions which when executed by a computer perform any of the methods of Example Embodiments D1 to D25.

### Group E Example Embodiments

Example Embodiment E1. A user equipment comprising: processing circuitry configured to perform any of the steps of any of the Group A Example Embodiments; and power supply circuitry configured to supply power to the processing circuitry.

Example Embodiment E2. A network node comprising: processing circuitry configured to perform any of the steps of any of the Group B, C, and D Example Embodiments; power supply circuitry configured to supply power to the processing circuitry.

Example Embodiment E3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, C, and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, C, and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, C, and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, C, and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, C, and D Example Embodiments to receive the user data from the UE for the host.

Example Embodiment E27. The method of the previous Example Embodiment, further comprising at the network node, transmitting the received user data to the host.

1. A method by a network node for operation of a control link and/or backhaul link, the method comprising:
sending, to a repeater node, a set of candidate Transmission Configuration Indicator, TCI, states;
indicating, to the repeater node, a multiplexing operational mode of the control link and the backhaul link of the repeater node for a time resource; and
indicating, to the repeater node, an indication of a TCI state for at least one of the control link and the backhaul link of the repeater node for the time resource based on the multiplexing operational mode.

2. The method of claim 1, comprising receiving, from the repeater node, a backhaul link beam capability report, wherein the backhaul link beam capability report comprises at least one of:
an indication that the repeater node supports simultaneous transmission and/or reception of the control link and the backhaul link; and
an indication that the repeater node supports adaptive beamforming of the control link and/or the backhaul link.

3. The method of claim 1, wherein the set of candidate TCI states comprises:
at least one candidate TCI state for simultaneous operation of the backhaul link and the control link; and
at least one candidate TCI state for the operation of the backhaul link only.

4. The method of claim 1, wherein the multiplexing operational mode of the control link and the backhaul link comprises at least one of:
simultaneous operation with the control link in at least one of a downlink direction and an uplink direction; and
time domain multiplexing with the control link in at least one of the downlink direction and the uplink direction.

5. The method of claim 4, wherein the multiplexing operational mode is indicated implicitly.

6. The method of claim 1 comprising determining the multiplexing operational mode of the control link and the backhaul link based on at least one of:
a reported backhaul beam capability of the repeater node;
a Time Division Duplex, TDD, pattern for at least one of an uplink and a downlink;
a network interference level;
an energy saving mode of a Mobile Termination, MT, (60) of the repeater node;
a need of an Acknowledgement, ACK, and/or Non-Acknowledgement, NACK, to or from the repeater node and/or to or from at least one User Equipment, UE

7. The method of claim 1, wherein the indication of the TCI state is based on at least one of:
an indicated beam for the control link; and
an indicated beam for the backhaul link.

8. The method of claim 7, wherein the indicated beam for the control link and/or the indicated beam for the backhaul link is determined based on at least one of:
a control link beam quality; and
a backhaul link beam quality.

9. The method of claim 1, wherein the time resource of the TCI state for simultaneous operation of the backhaul and control link can be associated to a signal or a channel configured to a Mobile Termination, MT, of the repeater node.

10. The method of claim 1, wherein, in the absence of a transmission and/or reception on the control link, the indication of the TCI state for the backhaul link is based on at least one of:
a default backhaul beam;
a predefined rule or specification;
an indicated TCI state for the repeater control link; and
a dedicated backhaul beam indication based on measurement from the repeater node.

11. The method of claim 1, wherein, in the absence of a transmission and/or reception on the control link, the time resource for the TCI state for the backhaul link is associated to a time domain resource configured to an access beam of a repeater-forward.

12. The method of claim 1, wherein the indication of the TCI state is transmitted via at least one of:
a Radio Resource Control, RRC, signal;
a Medium Access Control-Control Element, MAC CE; and
Downlink Control Information, DCI.

13. The method of claim 12, wherein the MAC CE indicating the TCI state contains a field indicating that the TCI state should be activated or deactivated only for the backhaul link.

14. The method of claim 1, wherein the set of candidate TCI states is for repeater backhaul link beams and is in a same Radio Resource Control, RRC, information element that provides at least one semi-statically configured TCI list for a Mobile Termination, MT, of the repeater node.

15. The method of claim 1, wherein the indication of the TCI state comprises a pointer to a TCI state in the set of candidate TCI states.

16. The method of claim 15, wherein:
the set of candidate TCI states is per sub-band, or
the set of candidate TCI states is common for multiple sub-bands.

17. A method by a repeater node for operation of a control link and/or a backhaul link, the method comprising:
receiving, from a network node, a set of candidate Transmission Configuration Indicator, TCI, states;
obtaining information indicating a multiplexing operational mode of the control link and the backhaul link of the repeater node for a time resource;
obtaining an indication of a TCI state for at least one of the control link and the backhaul link of the repeater node for the time resource based on the multiplexing operational mode; and
activating or deactivating the TCI state for the at least one of the control link and the backhaul link for the time resource based on the multiplexing operational mode.

18. The method of claim 17, comprising transmitting, to the network node, a backhaul link beam capability report, wherein the backhaul link beam capability report comprises at least one of:
an indication that the repeater node supports simultaneous transmission and/or reception of the control link and the backhaul link; and
an indication that the repeater node supports adaptive beamforming of the control link and/or the backhaul link.

19. The method of claim 17, wherein the set of candidate TCI states comprises:
at least one candidate TCI state for simultaneous operation of the backhaul link and the control link, and
at least one candidate TCI state for the operation of the backhaul link only.

20. The method of claim 17, wherein the multiplexing operational mode of the control link and the backhaul link comprises at least one of:
simultaneous operation with the control link in at least one of a downlink direction and an uplink direction; and
time domain multiplexing with the control link in at least one of the downlink direction and the uplink direction.

21. The method of claim 20, wherein the multiplexing operational mode is indicated implicitly.

22. The method of claim 17, wherein obtaining the information indicating the multiplexing operational mode of the control link and the backhaul link comprises determining the multiplexing operational mode based on at least one of:
a reported backhaul beam capability of the repeater node;
a Time Division Duplex, TDD, pattern for at least one of an uplink and a downlink;
a network interference level;
an energy saving mode of a Mobile Termination, MT (60), of the repeater node; and
a need of an Acknowledgment, ACK, and/or Non-Acknowledgment, NACK, to or from the repeater node and/or to or from at least one User Equipment, UE.

23. The method of claim 17, wherein the indication of the TCI state is based on at least one of:
an indicated beam for the control link; and
an indicated beam for the backhaul link.

24. The method of claim 23, wherein the indicated beam for the control link and/or the indicated beam for the backhaul link is determined based on at least one of:
a control link beam quality; and
a backhaul link beam quality.

25.-32. (canceled)

33. A network node for operation of a control link and/or a backhaul link, the network node adapted to:
send, to a repeater node, a set of candidate Transmission Configuration Indicator, TCI, states;
indicate, to the repeater node, a multiplexing operational mode of the control link and the backhaul link of the repeater node for a time resource; and
indicate, to the repeater node, an indication of a TCI state for at least one of the control link and the backhaul link of the repeater node for the time resource based on the multiplexing operational mode.

34. (canceled)

35. A repeater node for operation of a control link and/or a backhaul link, the repeater node adapted to:
receive, from a network node, a set of candidate Transmission Configuration Indicator, TCI, states;
obtain information indicating a multiplexing operational mode of the control link and the backhaul link of the repeater node for a time resource;
obtain an indication of a TCI state for at least one of the control link and the backhaul link of the repeater node for the time resource based on the multiplexing operational mode; and
activate or deactivate the TCI state for the at least one of the control link and the backhaul link for the time resource based on the multiplexing operational mode.

36. (canceled)
